(19) United States
(12) Patent Application Publication
(10) Pub. No.: US 2014/0248713 A1
(43) Pub. Date: Sep. 4, 2014

(54) Method for Observing at Least One Object, Such as a Biological Entity, and Imaging System Associated Therewith

(71) Applicant: Commissariat à l'énergie atomique et aux énergies alternatives, Paris (FR)

(72) Inventors: Cédric ALLIER, GRENOBLE (FR); Fabrice NAVARRO Y GARCIA, FONTAINE (FR); Vincent POHER, GUINES (FR); Patrick POUTEAU, MEYLAN (FR)

(73) Assignee: Commissariat à l'énergie atomique et aux énergies alternatives, Paris (FR)

(21) Appl. No.: 14/193,714

(22) Filed: Feb. 28, 2014

(30) Foreign Application Priority Data
Feb. 28, 2013 (FR) 13 51787

(51) Int. Cl. G01N 21/64

(52) U.S. Cl. CPC G01N 21/6428
USPC 436/501; 422/69

(57) ABSTRACT

This method for observing at least one object is applied by means of an imaging system. It includes the following steps:
illuminating the object(s), with a light source,
acquiring, by means of a photodetector array, a diffraction pattern, the diffraction pattern corresponding to an image of the waves diffracted by the object(s) when they are illuminated along an illumination direction,
the object(s) such as biological entities, being positioned between the light source and the photodetector array along the illumination direction.

The method further comprises, prior to the illumination step, addition of at least one marker in contact with the object(s), said or each marker being adapted to bind onto a corresponding object, the binding of said marker onto said object being adapted for increasing at least one characteristic quantity from among the absorption and the optical phase shift of said object.

### BACKGROUND OF THE INVENTION

The present invention relates to a method for observing at least one object, such as a biological entity. The method is applied by means of an imaging system, and includes the illumination of the object(s) with a light source, and the acquisition of a diffraction pattern by means of a photodetector array, the diffraction pattern corresponding to an image of the waves diffracted by the object(s) when they are illuminated along an illumination direction. The object(s) is(are) positioned between the light source and the photodetector array along the illumination direction.

The present invention also relates to an imaging system comprising a light source adapted for illuminating along an illumination direction at least one object, such as a biological entity, to a photodetector array adapted for acquiring a diffraction pattern, to the diffraction pattern corresponding to an image of the wave diffracted by the object(s) when they are illuminated along said illumination direction, and to a support for receiving the object(s), a support being positioned between the light source and the photodetector array along the illumination direction.

The invention for example applies to the reconstruction of an image of a sample including objects, notably to the reconstruction of optical properties of the objects, such as biological entities, for example cells, bacteria or further viruses. These biological entities, also called biological particles, have a size of the order of 10 μm for cells and of the order of 1 μm for bacteria. The sample is for example immersed in a liquid medium contained in the support. The support being positioned between the source and the photodetector array, the support including a transparent surface positioned facing the photodetector array. Alternatively, the sample is positioned on the support in contact with air.

By optical properties, is notably meant the absorption of the object or the optical phase shift introduced by each object, the optical phase shift being also called a phase lag, being aware that these parameters respectively represent the modulus and the argument of the complex opacity function of the object. With the invention, it is notably possible to determine the spatial distribution of these parameters.

The invention relates to imaging without any lens, also called lensless imaging, also called contact imaging, i.e. the acquisition by the photodetector array of images formed by the radiation directly transmitted by the sample, in the absence of magnification optics positioned between the sample and the photodetector array. The photodetector array is also called in this case, an imaging device without any lens and adapted for forming an image of the sample while being placed at a small distance from the latter. By small distance, is meant a distance comprised between 100 μm and a few centimeters, preferably less than 1 cm.

A method of the aforementioned type is known from the article <<Lensfree super resolution holographic microscopy using wetting films on a chip>> of Mudanyali, of W. Bishara and A. Ozcan, published in 2011 in the Optics Express journal. This article describes lens-free imaging of biological particles, in particular biological particles having dimensions of less than 0.5 μm, such as particles of Escherichia coli, spermatozoids, Giardia lamblia trophozoites, or further erythrocytes, also called red corpuscles. This article in particular describes the use of a wetting film in order to improve the obtained images. The wetting film has a very small thickness, and is positioned above the sample containing the biological particles.

However, the images of the diffraction patterns acquired by the photodetector array are wide field images for observing thousands of particles, but do not allow easy discrimination of the particles relatively to each other.

### SUMMARY OF THE INVENTION

The object of the invention is therefore to propose an observation method and an imaging system giving the possibility of improving observation of certain objects of the sample, while always observing thousands of objects by means of the images of the acquired diffraction patterns.

For this purpose, the object of the invention is an observation method of the aforementioned type, wherein the method further comprises, prior to the illumination step, the addition of at least one marker in contact with the object(s), said or each marker being adapted to bind onto a corresponding object, the binding of said marker on said object being adapted to increase at least one characteristic quantity from among the absorption and optical phase shift of said object.

According to other advantageous aspects of the invention, the observation method comprises one or more of the following features, taken individually or according to all the technically possible combinations:
the binding of the marker on said object is adapted to increase the absorption of said object by at least 1%, preferably by at least 10%;
the binding of said marker on said object is adapted to increase the optical phase shift of said object by at least π/10 radians;
said or each marker is selected from the group consisting of: a coloring agent, a fluorescent agent, a metal particle and an organic particle;
said or each marker has a dimension, such as a diameter with a value of less than half of the corresponding dimension, such as a diameter, of said or each object, preferably less than one third of said dimension, still preferably less than one tenth of said dimension;
the distance between the object(s) and the photodetector array along the illumination direction is less than 10 mm, preferably less than 5 mm;
the light source is a source of spatially coherent light;
said or each object has a dimension, such as a diameter, with a value of less than 1 mm, preferably with a value comprised between 100 nm and 100 μm;
the method further comprises, after the acquisition step, reconstruction of optical properties of the object(s) according to a reconstruction algorithm from an intensity measured by the photodetector array, the reconstruction algorithm depending on the distance between the object(s) and the photodetector array along the illumination direction, and
the method further comprises a step for counting the objects to which at least one marker is bound.

The object of the invention is also an imaging system of the aforementioned type, wherein the receiving support further includes at least one marker laid out in contact with the object(s), said or each marker being adapted to be bound on a corresponding object, the binding of said marker on said object being adapted to increase at least one characteristic quantity from among the absorption and optical phase shift of said object.

### BRIEF DESCRIPTION OF THE DRAWINGS

The features and advantages of the invention will become apparent upon reading the description which follows, only given as a non-limiting example, and made with reference to the appended drawings, wherein:

FIG. 1 is a perspective view of an imaging system according to the invention,

FIG. 2 is an exploded view of the imaging system of FIG. 1,

FIG. 3 is a schematic illustration of the imaging system of FIG. 1, the imaging system comprising a light source adapted to illuminate a sample, positioned on a receiving support, and a photodetector array adapted to establish a diffraction pattern transmitted by the illuminated sample,

FIG. 4 is a flow chart of an observation method according to the invention,

FIG. 5 is an image of a diffraction pattern of the sample, acquired according to an observation method of the state of the art,

FIG. 6 is an image of a diffraction pattern of the sample, acquired in accordance with an observation method according to the invention,

FIG. 7 is an enlargement of the framed area VII of FIG. 5,

FIG. 8 is an enlargement of the framed area VIII of FIG. 6,

FIG. 9 is an enlargement, for the area corresponding to the framed area VII of FIG. 5, of an image of the sample obtained by reconstruction according to the method of the state of the art,

FIG. 10 is an enlargement, for the area corresponding to the framed area VIII of FIG. 6, of an image of the sample obtained by reconstruction in accordance with the method according to the invention,

FIG. 11 is an enlargement, for the same area as the one of FIGS. 9 and 10, of a reference image of the sample, obtained by means of an imaging system by fluorescence,

FIG. 12 is a view of the image of the sample obtained by reconstruction in accordance with the method according to the invention, said view including the framed area X, an enlargement of which is illustrated in FIG. 10, and

FIG. 13 is a view of the receiving support according to a second exemplary embodiment, the support including a first well including lyzed blood to be observed according to an observation method of the state of the art and a second well including lyzed blood and markers in the form of magnetic microbeads to be observed in accordance with the observation method according to the invention,

FIG. 14 is an image of diffraction patterns of the framed area XIV of FIG. 13, acquired in accordance with the observation method of the state of the art,

FIG. 15 is an image of diffraction patterns of the framed area XV of FIG. 13, acquired in accordance with the observation method according to the invention,

FIG. 16 is an image of the framed area XIV of FIG. 13, acquired with a microscope,

FIG. 17 is an image of the framed area XV of FIG. 13, acquired with the microscope,

FIG. 18 is a set of concatenated images of different areas of the second well of FIG. 13, acquired with the microscope,

FIG. 19 is a set of concatenated images of different areas of the second well of FIG. 13, acquired according to the observation method of the invention,

FIG. 20 is a set of enlargements of patterns to which point arrows in FIG. 18,

FIG. 21 is a set of enlargements of patterns to which point arrows in FIG. 19,

FIG. 22 is an image of the second well of FIG. 13, acquired in accordance with the observation method according to the invention,

FIG. 23 is a reference image,

FIG. 24 is a detection image obtained by thresholding from autocorrelation between the image of FIG. 22 and that of FIG. 23,

FIG. 25 is a view of the receiving support according to a third exemplary embodiment, the support including a first well including macrophages to be observed according to an observation method of the state of the art and a second well including macrophages and markers in the form of magnetic microbeads to be observed in accordance with the observation method according to the invention,

FIG. 26 is a set of images of different areas of the first well of FIG. 25, acquired with the microscope,

FIG. 27 is a set of images of diffraction patterns of different areas of the first well of FIG. 25, acquired according to the observation method of the state of the art,

FIG. 28 is a set of curves in grey levels corresponding to the images of FIG. 27,

FIG. 29 is a set of images of different areas of the second well of FIG. 25, acquired with the microscope,

FIG. 30 is a set of images of diffraction patterns of different areas of the second well of FIG. 25, acquired in accordance with the observation method according to the invention, and

FIG. 31 is a set of curves in grey levels corresponding to the images of FIG. 30.

### DETAILED DESCRIPTION OF PREFERRED EMBODIMENTS

Conventionally, in the present application, the expression <<substantially equal to >> will express an equality relationship to within plus or minus 5%.

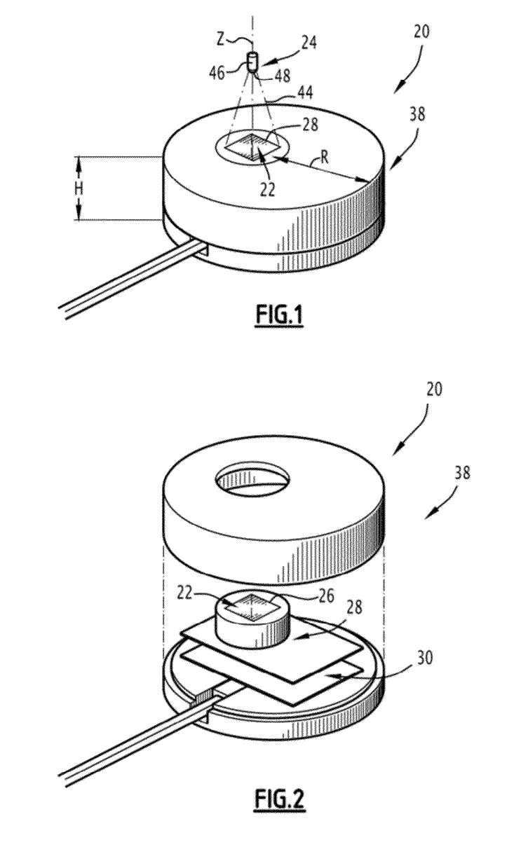

In FIG. 1, an imaging system 20 intended for the observation of a sample 22 comprises a light source 24 adapted to illuminate the sample 22 and a photodetector array 26 adapted to establish a diffraction pattern transmitted by the sample 22 illuminated along an illumination direction, for example a substantially vertical direction Z.

The imaging system 20 comprises a support 28 for receiving the sample 22, the receiving support 28 being positioned between the light source 24 and the photodetector array 26 along the illumination direction Z. The receiving support 28 is intended to receive the sample 22 to be analyzed.

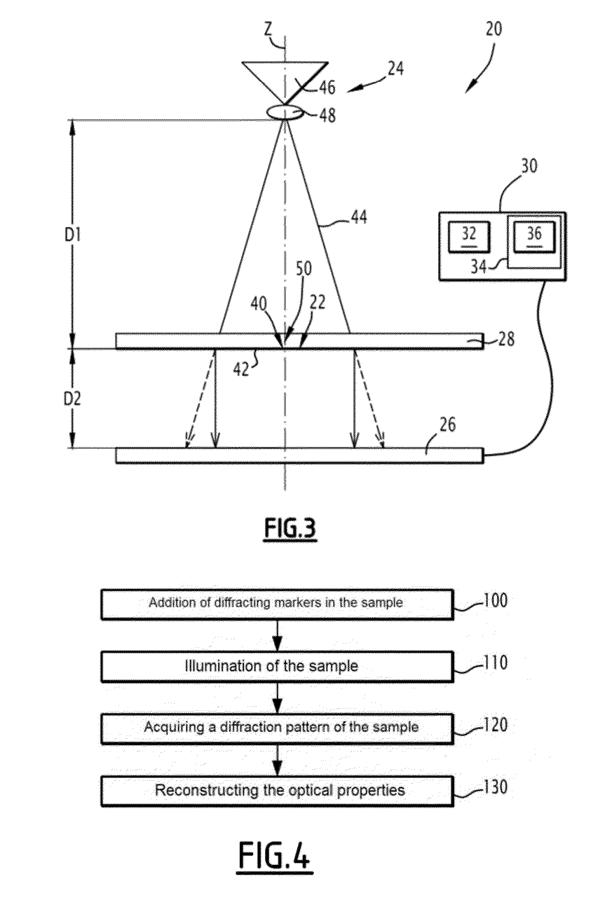

The imaging system 20 also comprises a unit 30 for processing information, visible in FIG. 3, including a processor 32 and a memory 34 adapted to store software 36 for reconstructing the optical properties of the sample 22, the optical properties being reconstructed according to a reconstruction algorithm from an intensity I measured by the photodetector array 26.

The imaging system 20 comprises a protective casing 38, inside which are notably positioned the photodetector array 26 and the information processing unit 30, as illustrated in FIG. 2.

The sample 22 includes objects 40, such as biological entities, also called biological particles, i.e. cells (for example red corpuscles, white corpuscles, or platelets) or aggregates of cells, bacteria or bacterial colonies, or further viruses.

The sample 22 is for example immersed in a liquid medium contained in the support 28, the support 28 including a transparent surface 42 and the objects for example being in contact with the transparent surface 42 of the support. Alternatively, the sample 22 is positioned on the support 28 in contact with air, the objects 40 being laid out on the transparent surface 42 of the support.

The light source 24 is adapted to emit a light beam 44 along the illumination direction, for example the vertical direction Z, in order to illuminate the sample 22 comprising the objects 40. The illumination direction is the direction along which the sample 22 is illuminated by the light beam 44. The illumination direction is not necessarily the direction along which the light beam 44 emerges from the light source 24, notably in the case when the light beam 44 does not follow a rectilinear path from the light source 24 as far as the sample 22, the light beam 44 then for example being reflected by a mirror during its propagation between the light source 24 and the sample 22.

The light source 24 is positioned at a first distance D1 of the receiving support 28 along the illumination direction Z. The first distance D1 preferably has a value comprised between 1 mm and 30 cm.

The light source 24 is preferably a spatially coherent source and for example includes a point-like source such as a light-emitting diode 46 also called a LED, and, advantageously a diaphragm 48 positioned in contact with the LED 46. This allows an increase in the spatial coherence of the light radiation. When the light source 24 includes the LED 46, the first distance D1 is, for example, equal to 5 cm.

Alternatively, the light source 24 is a spatially and temporally coherent light source such as a laser diode (LD) or further a laser diode of the VCSEL type (Vertical Cavity Surface Emitting Laser). The laser diode has a wavelength for example substantially equal to 670 nm. When the light source 24 is a laser diode, the first distance D1 is for example equal to 1 cm. One skilled in the art will note that the value of the first distance D1, i.e. a distance between the light source 24 and the sample 22, does not affect the diffraction pattern, given that the wave emitted by the light source 24 is a plane wave, and this regardless of the position of the light source 24.

Still alternatively, the light source 24 consists of the light emitting diode 46 and does not include any diaphragm. The light emitting diode 46 then has sufficiently reduced dimensions so as to be considered as spatially coherent, the diameter of the light emitting diode 46 being less than one tenth of the first distance D1 separating this light emitting diode 46 from the receiving support 28.

The photodetector array 26 is adapted to establish a diffraction pattern produced by the sample 22, said or each diffraction pattern corresponding to an image of the waves diffracted by one or more objects 40, the image being formed at the photodetector array 26 during the illumination of the sample 22. More specifically, each diffraction pattern comprises an image formed by the interferences of the waves diffracted by an object. The photodetector array 26 and the light source 24 are located on either side of the sample 22 along the illumination direction Z.

The photodetector array 26 includes a plurality of pixels, not shown. Each pixel of the photodetector array 26 has dimensions of less than or equal to 10 μm, or even 4 μm. Each pixel is for example square-shaped, the side of which is of a value of less than or equal to 10 μm, or even 4 μm. Alternatively, each pixel has the shape of a square with a side of 2.2 μm.

The photodetector array 26 is positioned at a second distance D2 from the receiving support 28 along the illumination direction Z. The second distance D2 has a value comprised between 100 μm and a few centimeters, preferably less than 10 mm, preferably less than 5 mm and still preferably comprised between 200 μm and 2 mm. In the exemplary embodiment described, the second distance D2 is substantially equal to 500 μm.

The fact of giving preference to a second distance D2 of small value, i.e. a short distance between the photodetector array 26 and the receiving support 28, gives the possibility of limiting the interference phenomena between different diffraction patterns produced by different objects when the sample 22 is illuminated.

The photodetector array 26 is a two dimensional image sensor, i.e. in a plane perpendicular to the illumination direction Z. The photodetector array 26 is a pixelated image sensor, for example a CMOS (Complementary Metal-Oxide Semiconductor) sensor. Alternatively, the photodetector array 26 is a CCD (Charge-Coupled Device) sensor.

The photodetector array 26 additionally includes micro-lenses, not shown, each micro-lens being positioned above a corresponding pixel. Such micro-lenses are integrated to a sensor. They allow an improvement in the collection yield and do not form magnification optics located between the receiving support 28 and the photodetector array 26.

The images acquired by the photodetector array 26 are formed with the radiation directly transmitted through the sample 22, in the absence of magnification optics positioned between the receiving support 28 and the photodetector array 26. The photodetector array 26 is also called a lens-free imaging device, and is adapted to form an image of the sample 22, while being placed at a small distance from the latter. By small distance is meant as indicated earlier, a distance of less than a few centimeters, preferably less than 1 cm, the second distance D2 for example being equal to 500 μm.

The receiving support 28 includes the transparent surface 42 supporting the sample 22. The first distance D1 then corresponds to the distance between the light source 24 and the transparent surface 42 along the illumination direction Z. The second distance D2 then corresponds to the distance between the photodetector array 26 and the transparent surface 42 along the illumination direction Z.

The receiving support 28 is positioned between the light source 24 and the photodetector array 26, and the transparent surface 42 is substantially perpendicular to the illumination direction Z corresponding to the illumination direction of the sample 22 by the light source 24, as illustrated in FIG. 3.

The receiving support 28 further includes, according to the invention, at least one marker 50 laid out in contact with the object(s) 40, said or each marker 50 being adapted to be bound onto a corresponding object 40, the binding of said marker 50 on said object 40 being adapted to at least increase one characteristic quantity from among the absorption and the optical phase shift of said object 40. Preferably, this is a marking specific to the object 40 intended to be analyzed, the marking of the object consisting of adding to the object 40 a molecule, a particle, a cell by biological coupling.

Thus, generally, the sample 22 is illuminated along a given direction, the photodetector array 26 being positioned perpendicularly to said direction.

The reconstruction software 36 is adapted to reconstruct the optical properties of the sample 22, according to a construction algorithm, from the measured intensity I.

An example of a reconstruction algorithm, known per se, verifies the following equation:

$$I ( x , y ) * {h}_{- Zr} ( x , y ) = {e}^{j 2 π \frac{- Zr}{λ}} ( 1 - a ( x , y ) - {e}^{j 2 π \frac{2 Zr}{λ}} \cdot {a}^{*} ( x , y ) * {h}_{- 2 Zr} ( x , y ) ) \qquad ( 1 )$$

wherein I represents the intensity measured by the photodetector array 26,

x, y represent the coordinates in a plane perpendicular to the vertical direction Z, * designates the convolution product,

Zr represents a reconstruction height,

λ represents the wavelength of the light source 24, j represents the unit imaginary number,

a represents the complex opacity function of an object 40, a* represents the complex conjugate of a, and

h_{z} is defined by the following equation:

$${h}_{z} ( x , y ) = \frac{1}{j λ z} {e}^{j 2 π \frac{z}{λ}} exp ( j π \frac{{x}^{2} + {y}^{2}}{λ z} ) . \qquad ( 2 )$$

Equation (1) is obtained from the following equations:

A_{z}(x,y)=t(x,y)*h_{z}(x,y) (3)

wherein Az is the Fresnel transform of the transmittance t(x,y).

A transmission coefficient t(x,y) is then defined in the following way:

$$\begin{matrix}t ( x , y ) = ( 1 - a ( x , y ) ) & ( 4 ) \\ \begin{matrix}{A}_{z} ( x , y ) = t ( x , y ) * {h}_{z} ( x , y ) \\ = ( 1 - a ( x , y ) ) * {h}_{z} ( x , y ) \\ = 1 * {h}_{z} ( x , y ) - a ( x , y ) * {h}_{z} ( x , y ) \\ = {e}^{j 2 π \frac{z}{λ}} - a ( x , y ) * {h}_{z} ( x , y )\end{matrix} & ( 5 )\end{matrix}$$

The intensity I is then defined in the following way:

$$I = A \cdot {A}^{*} = 1 - {e}^{j 2 π \frac{z}{λ}} \cdot {a}^{*} * {h}_{z}^{*} - {e}^{- j 2 π \frac{z}{λ}} \cdot a * {h}_{z} + ( a * {h}_{z} ) \cdot ( {a}^{*} * {h}_{z}^{*} ) \qquad ( 6 )$$

The dual properties of the Fresnel transform corresponding to the following equations:

h_{z}^{*}*h_{z}=h_{-z}*h_{z}

h_{z}*h_{z}=h_{2z} (7)

then give the possibility of obtaining the reconstruction equation (1):

$$I * {h}_{- z} \approx ( 1 - {e}^{j 2 π \frac{z}{λ}} \cdot {a}^{*} * {h}_{z}^{*} - {e}^{- j 2 π \frac{z}{λ}} \cdot a * {h}_{z} ) * {h}_{- z} \\ I * {h}_{- z} = {e}^{j 2 π \frac{- z}{λ}} - {e}^{j 2 π \frac{z}{λ}} \cdot {a}^{*} * {h}_{z}^{*} * {h}_{- z} - {e}^{- j 2 π \frac{z}{λ}} \cdot a * {h}_{z} * {h}_{- z} \\ I * {h}_{- z} = {e}^{j 2 π \frac{- z}{λ}} - {e}^{j 2 π \frac{z}{λ}} \cdot {a}^{*} * {h}_{- z} * {h}_{- z} - {e}^{- j 2 π \frac{z}{λ}} \cdot a \\ I * {h}_{- z} = {e}^{j 2 π \frac{- z}{λ}} ( 1 - a - {e}^{j 2 π \frac{2 z}{λ}} \cdot {a}^{*} * {h}_{- 2 z} ) \qquad ( 8 )$$

The reconstruction height Zr corresponds to the distance between the photodetector array and the analyzed object.

According to an alternative, when the analyzed objects are placed in contact with the transparent wall 42, the reconstruction height Zr for example has a value strictly smaller than that of the second distance D2 between the transparent surface 42 and the photodetector array 26 along the illumination direction Z. The reconstruction height Zr is preferably less than 0.9 times the second distance D2, still preferably less than 0.8 times the second distance D2.

The protective casing 38 is for example in the shape of a cylinder, as illustrated in FIGS. 1 and 2. The protective casing 38 has a height H along the vertical direction Z, and a radius R along a radial direction perpendicular to the vertical direction Z. The height H and the radius R of the casing 38 are for example centimetric.

The objects 40 have a size of less than 1 mm, preferably comprised between 100 nm and 100 μm. The size of the objects 40 corresponds to their largest dimension along a given direction. When the objects 40 are in the form of a sphere, the size of the objects 40 is equal to the diameter of the corresponding sphere. Bacteria have a diameter of the order of 1 μm and the cells have a diameter of the order of 10 μm.

The size of the object 40 is generally comprised between 0.1 and 25 times the wavelength A of the beam 44 produced by the light source 24. In the example of FIGS. 5 to 12, the wavelength A of the beam 44 is equal to 555 nm, and the size of the objects 40 is of the order of 10 μm, i.e. equal to about 20 times the wavelength A.

The objects 40 for example are biological entities, such as bacteria or other micro-organisms, or further cells, as this was described earlier. The cells for example are blood cells, i.e. red corpuscles or white corpuscles, thrombocytes or further any other cells present in a biological fluid.

The transparent surface 42 is for example in the shape of a transparent slide, having a thickness substantially equal to 170 μm along the illumination direction Z.

The light beam 44 is adapted to directly illuminate the sample 22, in the absence of any magnification optics positioned between the light source 24 and the receiving support 28.

The light emitting diode 46 is for example monochromatic with a band pass width for example comprised between 1 nm and 40 nm, preferably equal to 5 nm. The light-emitting diode 46 for example has an emission wavelength comprised between 500 nm and 600 nm and a power of the order of 1 Watt.

The diaphragm 48 has a diameter comprised between 50 μm and 500 μm, and is placed in contact with the source of the LED 46.

Each marker 50 is selected from the group consisting of: a coloring agent, a fluorescent agent, a metal particle and an organic particle.

When the marker 50 is a fluorescent agent, this is for example 4′,6-diamidino-2-phenylindole, also called DAPI.

When the marker 50 is a metal particle, i.e. an inorganic particle of the metal type, these are for example gold particles, platinum particles or further magnetic beads. Magnetic beads are for example magnetic nanoparticles, in particular those marketed by Miltenyi Biotec under reference 130-045-801.

Finally, when the marker 50 is an organic particle, these are for example polymeric particles of micelles, of lipid particles of the nano-emulsion type, or further liposomes encapsulating a contrast agent. The contrast agent is for example a fluorophore, a coloring agent, a semi-conducting nanometric particle, also called a nanocrystal (quantum dot), or further a metal complex.

The binding of the marker 50 on the corresponding object 40 is adapted to increase the absorption of said object 40 by at least 1%, preferably by at least 10%, notably when the marker 50 is a coloring agent or a fluorescent agent.

The binding of the marker 50 on the corresponding object 40 is adapted to increase the phase shift, i.e. the phase lag, of said object 40 by at least π/10 radians, notably when the marker 50 is a metal particle or an organic particle.

Each marker 50 has a size with a value of less than half of the size of the corresponding object 40, preferably less than one third of said size, still preferably less than one tenth of said size. The size of each marker 50 corresponds to its largest dimension along a given direction. When the marker 50 has the shape of a sphere, the size of the marker 50 is equal to the diameter of the corresponding sphere.

Each marker 50 is functionalized so as to be adapted to bind onto a corresponding object 40. In other words, the marker 50 has a specific affinity with the object 40 to be marked. For example, this is a chemical affinity, an electrostatic affinity, or further a shape affinity.

The functionalization of the marker 50 gives the possibility of specifically reinforcing the diffractive power of the object 40 relatively to the surrounding medium (fluid, other objects), i.e. increasing at least one characteristic quantity from among the absorption and optical phase shift of said object 40. The marker 50 is then also called a diffractive marker. Indeed, the functionalization of the marker 50 gives the possibility of obtaining a strong concentration of the latter at the surface of the object 40 relatively to the surrounding medium.

The functionalization of the marker 50 is for example obtained by grafting a targeting agent, such as an oligonucleotide, a polynucleotide, a protein (for example an antibody), of further a DNA or RNA fragment. The targeting agent may interact, for example by complexation or by hybridization, with a molecule of the object 40. By grafting the targeting agent on the marker 50, it is possible to establish chemical affinity with the object 40 to be marked.

Alternatively, the marker 50 is a particle adapted to be bound to the object 40 via an electrostatic force. These particles having electrostatic affinity with the object 40 to be marked are for example MagPrep® Silica MS particles marketed by Merck Millipore under references 1016440001 or 1016440005.

Alternatively, the market 50 is a material with a molecular imprint adapted to assume a mating shape with at least one portion of the object 40 in order to establish shape affinity with said portion of the object 40 to be marked.

When the objects 40 are white corpuscles with the antigen CD45, the markers 50 are for example fluorescein isothiocyanate particles coupled with a specific antibody of the CD45 antigen, fluorescein isothiocyanate being a fluorophore. These fluorescein isothiocyanate particles coupled with the specific antibody of the CD45 antigen are for example marketed by Becton Dickinson (BD) under reference 555482, or by Miltenyi Biotec under reference 130-098-043, or further by AbD Serotec from the Bio-Rad group under reference MCA87F. Alternatively, when the objects 40 are white corpuscles with the antigen CD45, the markers 50 are magnetic nanoparticles, for example marketed by Miltenyi Biotec under reference 130-045-801. Still alternatively, when the objects 40 are white corpuscles with the antigen CD45, the markers 50 are fluorescent particles Q655 for example marketed by Invitrogen under reference Q22154.

When the objects 40 are platelets with the antigen CD61, the markers 50 are for example fluorescein isothiocyanate particles coupled with a specific antibody of the CD61 antigen, such as those marketed by Becton Dickinson (BD) under reference 555753, or by AbD Serotec under reference MCA2588F, or further by Abcan under reference ab78447. Alternatively, when the objects 40 are platelets with the CD61 antigen, the markers 50 are nanoparticles, for example marketed by Miltenyi Biotec under reference 130-051-101.

The reconstruction method according to the invention will now be described by means of FIG. 4.

During the initial step 100, the marker(s) 50 is(are) added into the sample 22, said or each marker 50 being adapted to bind onto a corresponding object 40 because of the affinity between each marker 50 and the corresponding object 40, as described earlier.

During the following step 110, the sample 22 is illuminated by means of the light source 22, the light beam 44 being directed along the illumination direction Z when it illuminates the sample 22.

The intensity I of the radiation transmitted by the illuminated sample 22 is then measured during step 120 by the photodetector array 26. More specifically, the photodetector array 26 measures the intensity I of the diffraction patterns transmitted through the illuminated sample 22, each diffraction pattern corresponding to waves diffracted by the objects 40 during the illumination of the sample 22, certain objects 40 being further associated with one or several corresponding markers 50. The diffracted waves interfere with the incident wave.

The optical properties, notably the absorption and the phase lag, also called phase shift, of the objects 40 are finally reconstructed during step 130, by means of the reconstruction means 36, according to the reconstruction algorithm described earlier and from the measured intensity I. The phase lag corresponds to the argument of the complex opacity function a; the absorption corresponds to the modulus of the complex opacity function as defined earlier. Generally, a reconstruction image represents the spatial distribution of the absorption or of the phase lag.

In the example of FIGS. 5 to 12, the light-emitting diode 46 has an emission wavelength equal to 555 nm and a power equal to 1.7 W. The first distance D1 is substantially equal to 5 cm and the second distance D2 substantially equal to 500 μm.

In the example of FIGS. 5 to 12, the objects 40 are fibroblast cells, i.e. NIH3T3 cells of reference ATCC CRL 1658, cultivated in a full medium based on a modified Eagle medium, also called DMEM (Dulbecco Modified Eagle Medium), comprising 1% of antibiotics, i.e. penicillin and streptomycin (marketed by Gibco) and 10% of newborn calf serum (marketed by Pan Biotech). 60,000 NIH3T3 cells are thus bound onto a transparent slide, such as a slide marketed by Cytoo Chips, the slide then being placed in an incubator for 3 hours at 37° C.

In the example of FIGS. 6, 8, 10 and 12, the NIH3T3 fibroblast cells were further marked with a solution including 4′,6-diamidino-2-phenylindole (DAPI), for example marketed by Invitrogen under reference P36931. In other words in the exemplary embodiment of FIGS. 6, 8, 10 and 12, the markers are molecules of 4′,6-diamidino-2-phenylindole (DAPI).

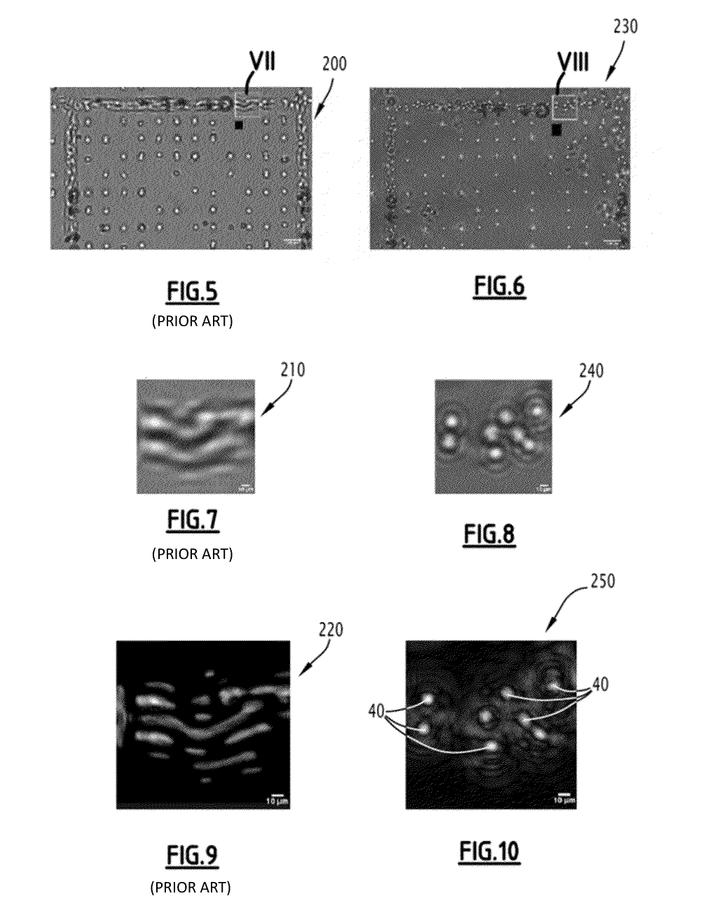

FIG. 5 illustrates an image 200 of diffraction patterns corresponding to the cells 40 before adding the solution including DAPI, i.e. acquired according to an observation method of the state of the art, FIG. 7 is an enlargement 210 of the framed area VII of FIG. 5 and FIG. 9 is an enlargement of 220 for the area corresponding to the framed area VII of FIG. 5, of the image obtained by reconstruction, from image 200, by means of a reconstruction software package 36 and according to the previous equations (1) to (8).

FIG. 6 illustrates an image 230 of diffraction patterns corresponding to the cells 40 after adding the solution including DAPI, i.e. acquired in accordance with an observation method according to the invention, FIG. 8 is an enlargement 240 of the framed area VII of FIG. 6, and FIG. 10 is an enlargement 250 for the area corresponding to the framed area VIII of FIG. 6, of the image 260 obtained by reconstruction, from image 230, by means of a reconstruction software package 36 and according to the previous equations (1) to (8). FIG. 10 is an enlargement of the framed area X of FIG. 12, FIG. 12 illustrating the image 260 obtained by reconstruction from the image 230.

In other words, FIGS. 5, 7 and 9 were achieved before adding markers in contact with the cells 40, i.e. according to the method of the state of the art, and FIGS. 6, 8, 10 and 12 were produced after adding the markers in contact with the cells 40, i.e. in accordance with the observation method according to the invention.

Comparison of FIGS. 7 and 8 then shows very distinctly that the diffraction patterns produced after marking in accordance with the method according to the invention are better defined than the diffraction patterns produced before marking according to the method of the state of the art.

The diffraction patterns produced in accordance with the method according to the invention then notably give the possibility of localizing, counting and measuring the nuclei of the cells 40.

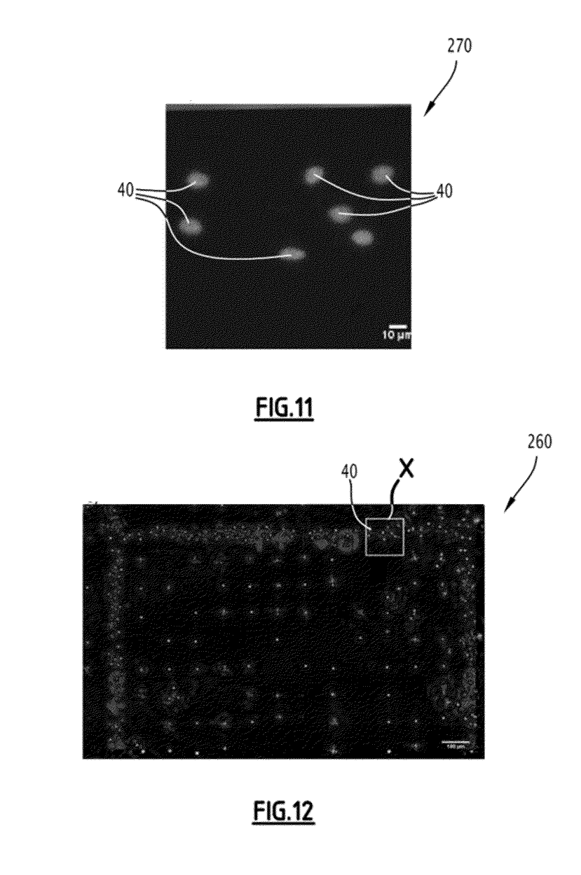

FIG. 11 is an enlargement 270, for the same area as that of FIGS. 9 and 10, of a reference image of the sample 22, obtained by means of an imaging system by fluorescence.

Comparison of FIGS. 10 and 11 then show that the image 260 reconstructed from the diffraction pattern obtained in accordance with the method according to the invention is a true picture of the reference image obtained by fluorescence imaging. Comparison of FIGS. 9 and 11 on the other hand shows that the reconstructed image from the diffraction pattern obtained according to the method of the state of the art cannot be utilized when the density of the cells is too high.

In the example of FIGS. 6, 8, 10 and 12, the addition of the solution including DAPI, in accordance with the method according to the invention, allows an increase in the absorption of the cells and the marking of the cells 40 then allows observation of a diffraction pattern which may be utilized and is specific to the nuclei of the cells 40.

It is thus understood that the observation method and the imaging system 20 according to the invention allow improvement in the observation of certain objects 40 of the sample 22 while always observing thousands of objects 40 by means of the images of the diffraction patterns.

Both exemplary embodiments which will be described subsequently with reference to FIGS. 13 to 24 on the one hand, and to FIGS. 25 to 31 on the other hand, show that by adding a diffracting marker 50 in the form of a microbead being selectively grafted on objects 40, in particular lymphocytes, it is possible to selectively observe these objects 40 by lens-less imaging.

The diffracting marker 50 in the form of a microbead then allows application of lens-less imaging for applications of the counting type or four ratios between different objects 40. The applications for example relate to diagnostics of pathologies such as HIV, tuberculosis, or malaria.

A second exemplary embodiment will now be described with reference to FIGS. 13 to 24. According to this second exemplary embodiment, the observed sample 22 includes fresh blood, which is conditioned in tubes, and the markers 50 are in the form of magnetic microbeads, for example having a diameter of about 4.5 μm.

100 μL of blood are then taken, which are incubated for 10 mins at +4° C. in 1 mL qsp of ultrapure water (UP H₂O) in order to lyze the red corpuscles. Next, the tubes are centrifuged at 500 G for 5 minutes, the supernatant is removed (this one essentially containing red corpuscle debris) and the sediment is taken up in 1.5 mL of phosphate buffered saline, also noted as PBS. This operation is repeated once.

Next, a tube is prepared, containing 450 μL of lyzed blood cells, from the previous sediment, with 50 μL of diffracting markers 50 in the form of magnetic beads with a diameter of about 4.5 μm, functionalized with a monoclonal anti-CD 45 mouse anti-body (IgG2a), CD 45 being a common surface marker of leukocytes. These functionalized magnetic microbeads are for example marketed under the name of Dynabeads® CD45 (Invitrogen™ 111.53D) by Life Technologies.

Non-incubated lyzed blood with diffracting markers 50 is used as a control, 10 μL is distributed into a first well 300 of the receiving support 28, visible in FIG. 13, such as an Invitrogen™ slide, for example marketed under reference Countess® Cell Counting Slides by Life Technologies.

After 30 mins of incubation at room temperature under weak stirring, a 10 μL volume is sample and distributed into a second well 302 of the receiving support 28, visible in FIG. 13, for observation with the microscope and in lens-less imaging.

FIG. 13 shows lens-less imaging acquisition of the receiving support 28 in the form of the Invitrogen™ slide. The receiving support 28 therefore contains, in the first well 300, 10 μL of a solution containing lyzed blood and in the second well 302, 10 μL of a same solution of lyzed blood but after marking of the lymphocytes with diffracting markers 50 in the form of magnetic microbeads Dynabeads® CD45.

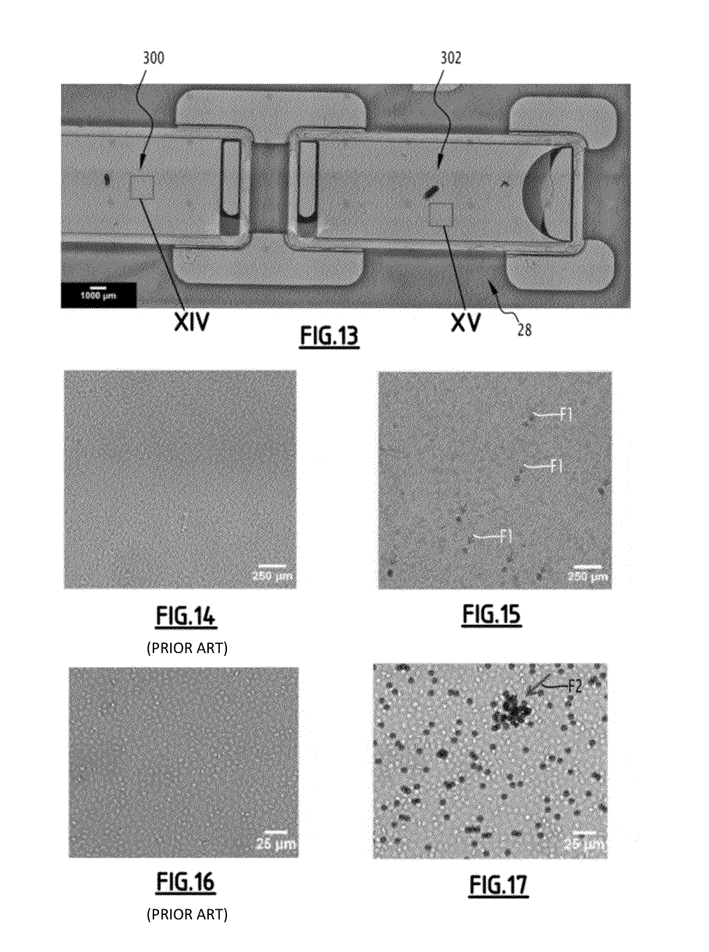

The image is obtained by means of a lens-less imaging system 20 including the array photodetector 26, such as an MT9J003 sensor marketed by Aptina Imaging™ and the light source 24, such as LED lighting filtered at 534 nm±42 nm. The receiving support 28 as a slide was scanned by means of two M.ILS-100PP stages marketed by Newport Corporation, an elementary image being obtained at each position of the slide. The elementary images produced are on a same slide are then juxtaposed so as to form a final image. The examples illustrated in FIGS. 14 and 15 are obtained by forming a mosaic of 45 elementary images.

FIGS. 14 and 15 show details of the framed areas XIV and XV of FIG. 13 obtained by lens-less imaging. As indicated earlier, FIGS. 14 and 15 respectively illustrate lyzed blood areas without diffracting markers 50 in the form of functionalized magnetic microbeads, such as Dynabeads® CD45 microbeads.

FIGS. 16 and 17 illustrate images respectively obtained in the first well 300 and in the second well 302, by means of a transmission microscope by using an objective with magnification equal to 50. Many debris of red corpuscles are observed. The field of observation of these figures is smaller than the field of observation of the images obtained by lens-less imaging.

In the first well 300 (FIG. 14), with the observation method of the state of the art, the acquisition obtained by lens-less imaging does not give the possibility of distinguishing the objects 40, and in particular the lymphocytes, the latter being widely a minority in the sample 22 (1 per 1000). The different particles present in the sample 22 are too close to each other. Therefore the diffraction spots mix together. FIG. 16, produced with a microscope, confirms observation of red corpuscle debris.

In the second well 302 (FIG. 15), containing according to the invention diffracting markers 50 in the form of functionalized magnetic microbeads, the image obtained by lens-less imaging reveals diffraction patterns which are distinct from the image background, and not present in the image obtained according to the method of the state of the art, without diffracting markers (FIG. 14). These diffraction patterns are located by arrows F1 in FIG. 15. FIG. 17, produced with the microscope, confirms that aggregates of microbeads form around the lymphocytes marked by functionalized magnetic microbeads (arrow F2), thereby allowing them to be distinguished from the debris, microbeads and other particles.

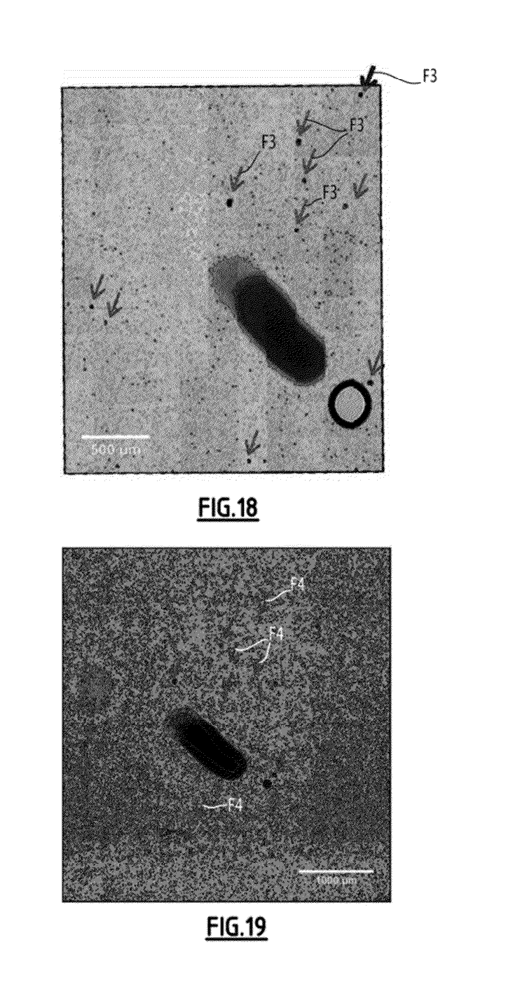

Matching the acquisitions obtained by lens-less imaging (FIG. 19) and by transmission microscopy (FIG. 18) shows that the diffraction patterns detected by lens-less imaging actually correspond to lymphocytes marked with magnetic microbeads. In FIGS. 18 and 19, the spot at the center of the image corresponds to an ink spot, used as a point of reference.

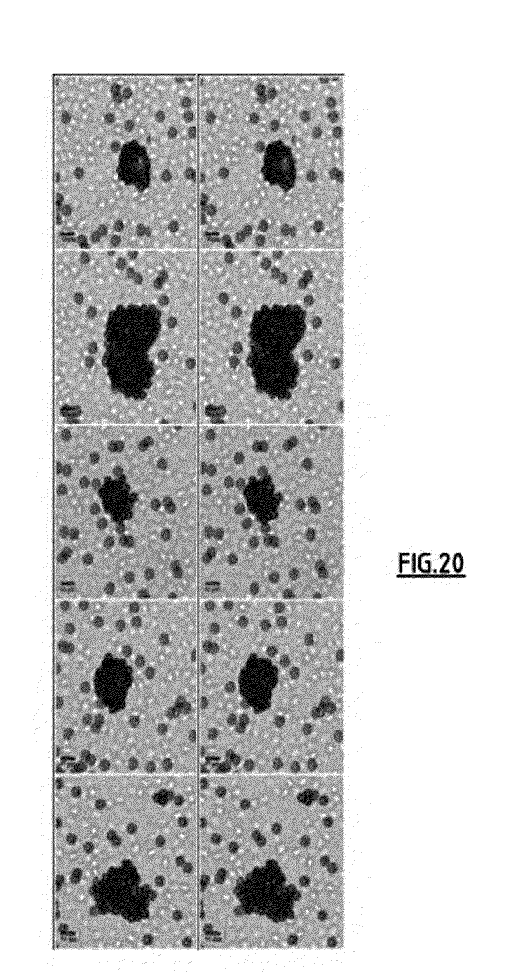

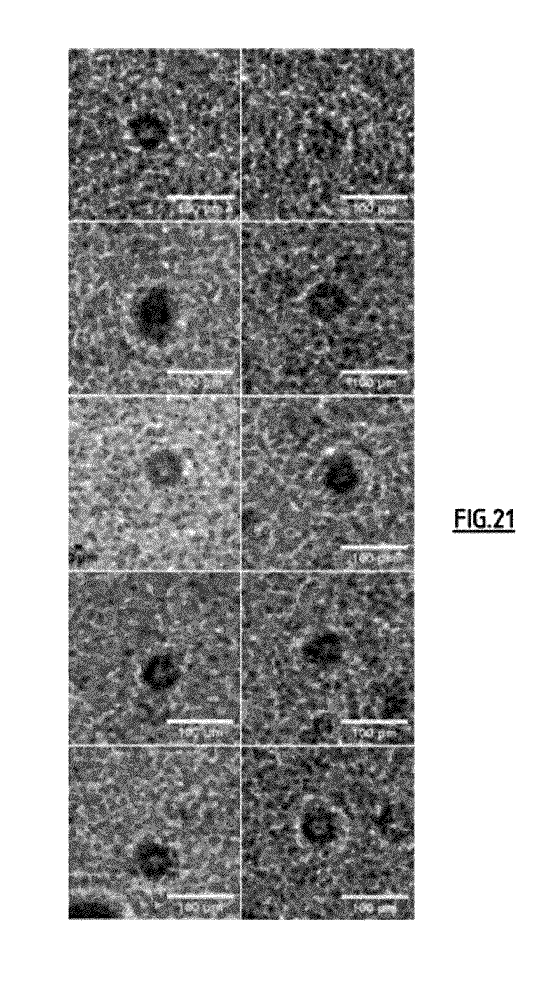

All the patterns to which point arrows F3, on the acquisition obtained by transmission microscopy in FIG. 18 are detailed in FIG. 20, and all the patterns to which point arrows F4, on the acquisition obtained by lens-less imaging in FIG. 19 are detailed in FIG. 21.

The patterns to which point the arrows F4 in FIG. 19 actually correspond to lymphocytes marked with the diffracting markers 50 in the form of magnetic microbeads, as confirmed by the reference images obtained by transmission microscopy by using an objective with magnification equal to 50, visible in FIGS. 18 and 20. The diffraction pattern recorded by lens-less imaging corresponding to the lymphocytes marked with the diffracting markers 50 in the form of microbeads has strong contrast in spite of the presence in its surroundings of many particles.

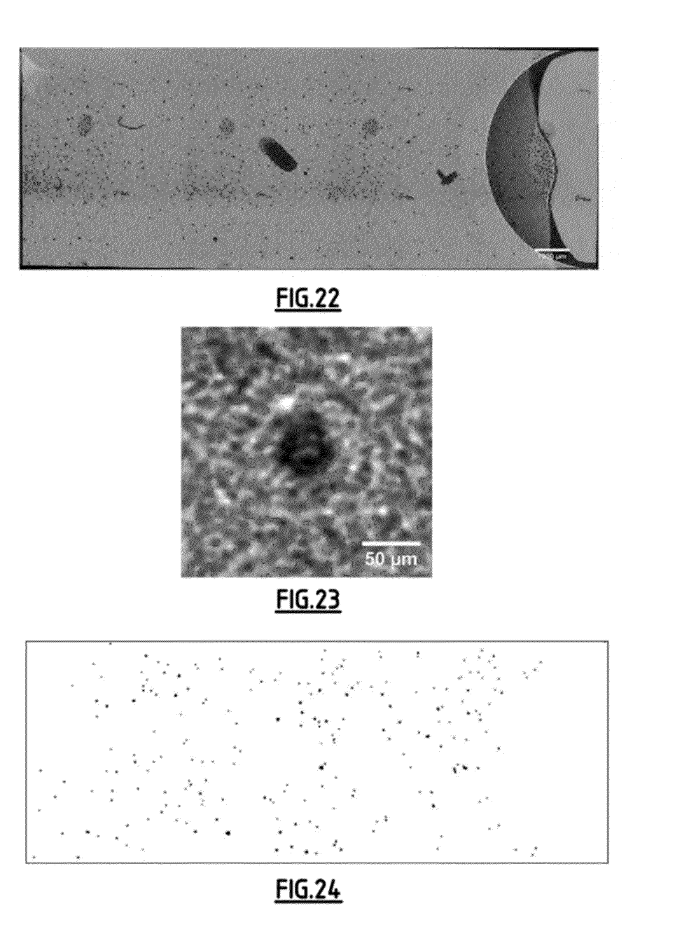

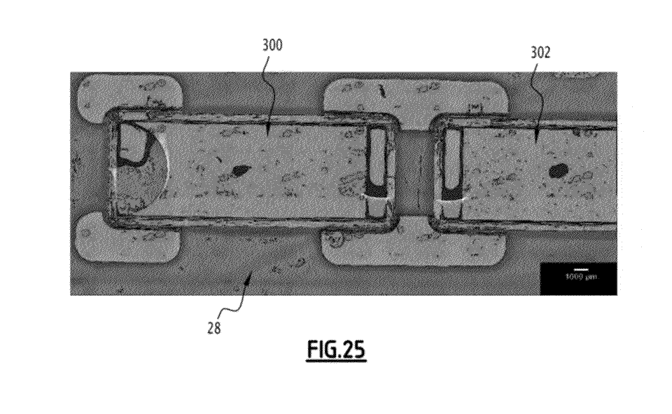

It is possible to detect these diffraction patterns manually, thereby revealing the presence of a marked particle. For automatic detection, an image processing method known per se is applied, this method including grey level thresholding, or a search for a reference pattern in the image. In the latter case, a comparison is performed between the image acquired by the lens-less imaging device (FIG. 22) and a reference pattern (FIG. 23), previously established, the latter being considered as representative of a diffraction pattern. A normalized autocorrelation between said acquired image I₁, visible in FIG. 22, and the reference image I₂, visible in FIG. 23 is then carried out. This gives the possibility of obtaining a correlation image I₃, visible in FIG. 24, after thresholding carried out from the result of the autocorrelation. On the latter image, each intensity peak in the detection image corresponds to the position of the center of the diffraction pattern.

If I₁(x,y) et I₂(i,j) respectively represent the observed image and a reference elementary diffraction pattern, applying an autocorrelation function, preferably a normed autocorrelation function, leads to a correlation image I₃ (x,y) such as:

$${I}_{3} ( x , y ) = \frac{{\sum }_{i , j} {I}_{2} ( i , j ) \times {I}_{1} ( x + i , y + j )}{\sqrt{{\sum }_{i , j} {I}_{2}^{2} ( i , j ) {\sum }_{i , j} {I}_{1}^{2} ( x + i , y + j )}} \qquad ( 9 )$$

In the example of FIGS. 22 to 24, the detection method by normalized autocorrelation leads to the detection of about 230 lymphocytes marked with diffracting markers 50 in the form of microbeads.

Thus, this second exemplary embodiment shows that by applying the diffracting marking, by grafting magnetic microbeads on the lymphocytes, it is possible to efficiently detect the lymphocytes by lens-less imaging, and this within a 10 μL highly complex and inhomogeneous solution of lyzed blood.

It is then understood that the marking of the objects 40 with diffracting markers 50 in the form of magnetic microbeads gives the possibility of from performing counting of the marked objects 40.

A third exemplary embodiment will now be described with reference to FIGS. 25 to 31. According to this third exemplary embodiment, the observed sample 22 includes murine macrophages, and the markers 50 are also in the form of magnetic microbeads, for example having a diameter of about 4.5 μm.

The murine macrophages, such as macrophages of the J774A.1 line, are maintained in cultivation in an incubator with a controlled atmosphere, with a humidity rate equal to 95% and 5% of common dioxide. On confluence, i.e. when the macrophages cover the culture support, the macrophages are sampled from the supports by scraping. About 250,000 cells of macrophages are deposited in a 1.5 mL tube containing phosphate buffered saline (PBS).

The cells are incubated for 30 minutes with weak stirring in the presence of a 1:10 dilution of diffracting markers 50 in the form of functionalized magnetic microbeads such as Dynabeads® CD45 microbeads (Invitrogen™ 111.53D) marketed by Life Technologies.

After incubation, a 1:100 dilution is performed in PBS. A 10 μL volume is then distributed into the second well 302 of the receiving support 28, their visible in FIG. 25, such as an Invitrogen™ slide, for example marketed under reference Countess® Cell Counting Chamber Slides by Life Technologies, for observation with a microscope or lens-less imaging. By the dilution, it is possible to reduce the number of cells to be observed. A solution of non-incubated macrophages with diffracting markers is used as a control, 10 μL are distributed into the first well 300 of the receiving support 28, visible in FIG. 25.

FIG. 25 shows acquisition by lens-less imaging of the receiving support 28 in the form of a slide. The receiving support 28 therefore contains in the first well 300, 10 μL of a solution containing macrophages, and in the second well 302, 10 μL of a same solution of macrophages but after marking of the macrophages with diffracting markers 50 in the form of Dynabeads® CD45 magnetic microbeads.

The image is obtained by means of a lens-less imaging system 20 including the array photodetector 26, such as an MT9J003 sensor from Aptina Imaging™, and the light source 24, such as LED lighting filtered at 610 nm±20 nm. The receiving support 28 in the form of a slide was scanned by means of two M.ILS-100PP stages from Newport Corporation, an elementary image being obtained at each position of the slide.

FIGS. 27, and respectively 30, show macrophages observed without any marking with the method of the state of the art, and respectively according to the invention with marking of the diffracting markers 50 in the form of Dynabeads® CD45 magnetic microbeads, these different images being obtained by lens-less imaging.

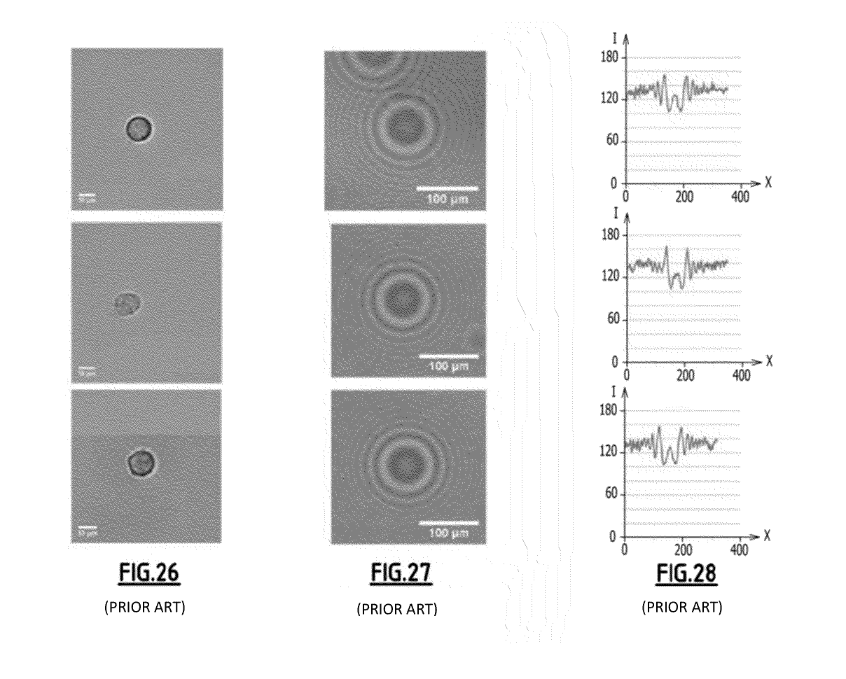

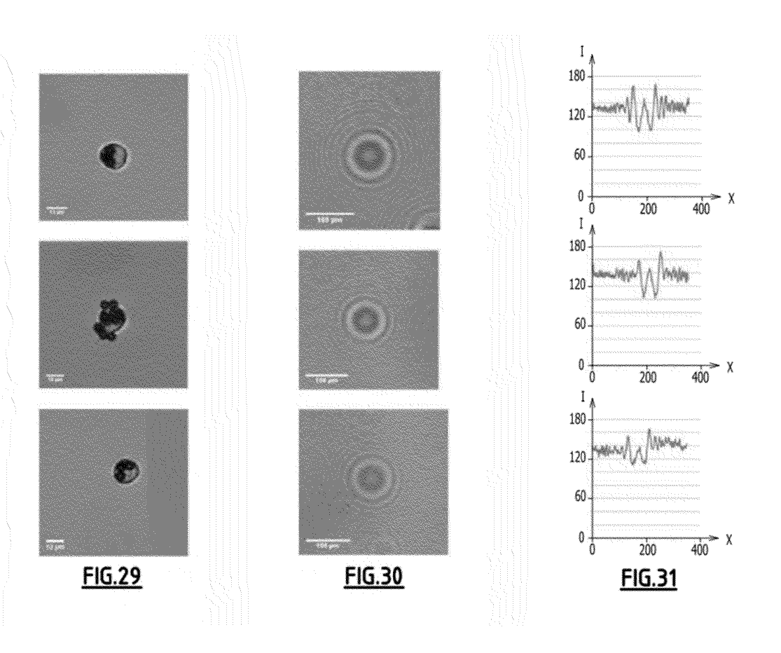

FIGS. 26 and 29 are obtained by respectively observing the first well 300 and the second well 302 by means of a transmission microscope with an objective of magnification equal to 50. These FIGS. 26 and 29 show that the macrophages of the first well 300 are actually without any diffracting markers whereas the macrophages of the second well 302 include several diffracting markers 50 in the form of magnetic microbeads at the surface of the cell.

By comparing FIGS. 27 and 30, it is observed that the diffraction patterns are different according to whether the observed objects 40 are marked (FIG. 30) or not (FIG. 27). This difference is for example observed on the profiles of the diffraction patterns, visible in FIG. 28 for the case of the first well 300 without any markers, and in FIG. 31 for the case of the second well 302 with distracting markers 50 in the form of magnetic microbeads. The profiles of the diffraction patterns are, in FIGS. 28 and 31, each time illustrated as a curve with in ordinates an intensity I expressed in grey levels of versus a distance X, expressed in micrometers, in abscissas.

The central peak on the profiles of the diffraction patterns is for example more intense when objects 40 marked with diffracting markers 50 are observed. It is therefore possible to apply a threshold on the central grey level, for example a value of 130 in the example of FIGS. 28 and 31, in order to distinguish the objects 40 marked with the diffracting markers 50 from the non-marked objects 40.

1. A method for observing at least one object, the method being applied by means of an imaging system and including the following steps:
illuminating object(s) with a light source,
acquiring, by means of a photodetector array, a diffraction pattern, the diffraction pattern corresponding to an image of the waves diffracted by the object(s) when they are illuminated along an illumination direction,
the object(s), being positioned between the light source and the photodetector array along the illumination direction,
wherein the method further comprises, prior to the illumination step:
addition of at least one marker in contact with the object(s), said or each marker being adapted to bind onto a corresponding object, the binding of said marker onto said object being adapted to increase at least one characteristic quantity from among the absorption and the optical phase shift of said object.

2. The method according to claim 1, wherein the binding of said marker onto said object is adapted to increase the absorption of said object by at least 1%.

3. The method according to claim 1, wherein the binding of said market onto said object is adapted to increase the optical phase shift of said object by at least π/10 radians.

4. The method according to claim 1, wherein said or each marker is selected from the group consisting of: a coloring agent, a fluorescent agent, a metal particle and an organic particle.

5. The method according to claim 1, wherein said or each marker has a dimension, such as a diameter, with a value of less than half of the corresponding dimension, such as a diameter, of said or each object.

6. The method according to claim 1, wherein the distance between the object(s) and the photodetector array along the illumination direction is less than 10 mm.

7. The method according to claim 1, wherein the light source is a spatially coherent light source.

8. The method according to claim 1, wherein said or each object has a dimension, such as the diameter, with a value of less than 1 mm.

9. The method according to claim 1, wherein the method further comprises after the acquisition step, reconstruction of the optical properties of the object(s) according to a reconstruction algorithm from an intensity measured by the photodetector array, the reconstruction algorithm depending on the distance between the object(s) and the photodetector array along the illumination direction.

10. The method according to claim 1, wherein the method further comprises a step for counting the objects to which at least one marker is bound.

11. An imaging system comprising:
a light source adapted for illuminating at least one object,
a photodetector array adapted for acquiring a diffraction pattern, the diffraction pattern corresponding to an image of the waves diffracted by the object(s) when they are illuminated along an illumination direction,
a support for receiving the object(s), the support being positioned between the light source and the photodetector array along the illumination direction,
wherein the receiving support further includes at least one marker laid out in contact with the object(s), said or each marker being adapted for binding onto a corresponding object, the binding of said marker onto said object being adapted for increasing at least one characteristic quantity from among the absorption and optical phase shift of said object.
